(19) United States
(12) Patent Application Publication
(10) Pub. No.: US 2026/0054859 A1
(43) Pub. Date: Feb. 26, 2026

(54) Modular spacecraft architecture

(71) Applicant: Planetary Utilities Corporation, Altadena, CA (US)

(72) Inventors: Johannes Gross, Altadena, CA (US); Adam Friedman, Palmdale, CA (US)

(73) Assignee: Planetary Utilities Corporation, Altadena, CA (US)

(21) Appl. No.: 19/305,503

(22) Filed: Aug. 20, 2025

Related U.S. Application Data
(60) Provisional application No. 63/685,094, filed on Aug. 20, 2024.

(51) Int. Cl. B64G 1/22; B64G 1/10; B64G 1/42

(52) U.S. Cl. CPC B64G 1/223; B64G 1/105; B64G 1/222; B64G 1/428

(57) ABSTRACT

A modular spacecraft includes a backbone support structure to provide structural support and integrate various functional networks. The backbone support structure is equipped with mechanical connectors for the secure attachment of multiple modules, and supports a plurality of network systems that includes power distribution, data transmission, and a thermal fluid loop. This modular design allows for the flexible and scalable assembly of the modular spacecraft, enabling different configurations and facilitating the integration of various modules with distinct functions or payloads. The backbone support structure's integrated networks ensure that all modules operate cohesively, enhancing the modular spacecraft's operational efficiency and adaptability.

### CROSS-REFERENCE

This application claims the benefit of provisional application 63/685,094 filed Aug. 20, 2024, which is incorporated herein by reference.

### BACKGROUND

### Field of the Invention

The present invention relates to spacecraft systems, more specifically to modular spacecraft architectures designed for flexible assembly, reconfiguration, and scalability in space missions. The invention pertains to the structural design, networking, and integration of spacecraft modules, enabling the construction and operation of spacecraft with varying configurations, functionalities, and sizes. This includes applications in satellite platforms, space stations, and exploration missions, where adaptability, ease of maintenance, and expandability are critical.

### Description of the Related Art

The International Space Station (ISS) represents a significant milestone in modular spacecraft design. The ISS is composed of numerous interconnected modules, each serving a specific function, such as laboratories, living quarters, and power systems. These modules are assembled and integrated in space, with a focus on flexibility and scalability. The ISS employs a partially modular architecture where modules are attached to a central truss structure. Power, data, thermal fluid loops and structural support are supplied by a central system. Orbital Replacement Units (ORU) are modular components that feature predefined interfaces that facilitate the exchange of such modules on orbit.

However, despite its modular approach, the ISS faces several limitations, for example:

Fixed and Pre-Planned Configuration: The ISS modules are integrated based on a fixed design and pre-determined configuration. Modifying or reconfiguring the ISS is a complex and labor-intensive process requiring significant user, e.g., astronaut involvement and planning.

Complex and Specialized Interfaces: The ISS modules utilize specialized and complex interfaces and docking mechanisms that are unique to each module type, requiring custom interfaces and making reconfiguration difficult.

Limited Scalability and Network Integration: While the ISS has power, data, and thermal networks, these are limited by the fixed configuration and cannot be easily extended.

Manual Assembly and Deployment: The ISS relies heavily on user, e.g., astronaut, involvement for module assembly and deployment.

### SUMMARY

Embodiments as discussed herein are at least directed to overcoming the deficiencies of prior systems by being directed to a modular spacecraft architecture with a central backbone support structure that is configured to connect to a plurality of modules. The backbone support structure is configured to host and/or connect various networks for providing power, transmitting data, and providing thermal protection using thermal fluid loops, creating a cohesive spacecraft. Additionally, a robotic system can be used for connecting/disconnecting modules and deploying mechanisms in space, which simplifies spacecraft assembly and increases flexibility. This modular system is designed or otherwise configured to allow for various configurations of the backbone support structure(s) and the modules, accommodating a wide range of spacecraft designs, including 3D structures, such as, tetrahedrons and pyramids.

In an embodiment, a modular spacecraft is provided. The modular spacecraft includes a backbone support structure configured to provide structural support and host a plurality of networks; and a plurality of modules connected to the backbone support structure. The plurality of modules includes mechanical connectors for securing the plurality of modules to the backbone support structure, and one or more of the plurality of modules further include connectors for connecting to one or more of the plurality of networks in the backbone support structure, wherein the one or more of the plurality of networks include one or more of a power distribution network, a data transmission network, and a thermal fluid network.

In another embodiment, a backbone support structure for a modular spacecraft architecture is provided. The backbone support structure includes a linear structure configured to provide a structural framework to support a plurality of modules, and mechanical connectors for connecting to a plurality of modules. The backbone support structure is configured to host a plurality of networks, in which the plurality of networks include one or more of a power distribution network, a data transmission network, and a thermal fluid network. The backbone support structure includes a standardized interface for detachably connecting one or more of the plurality of modules and/or other backbone support structures in various orientations.

In yet another embodiment, a method for deploying a modular spacecraft structure in space is provided. The method includes launching a modular spacecraft in a compact configuration, in which the spacecraft comprises a backbone support structure and a plurality of modules connected to the backbone support structure; positioning the modular spacecraft in an intended orbital location; activating a robotic system to traverse along the backbone support structure. The robotic system is configured to: detach one or more modules of the plurality of modules from the compact configuration; reposition and connect the one or more modules to the backbone support structure or to other modules based on a pre-determined configuration.

Other features and aspects of the embodiments will become apparent by consideration of the following detailed description and accompanying drawings.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments. Furthermore, the diagrams and figures showing the locations are for schematic illustrations of some of the embodiments, but are not representative of any required location and are not intended to be limiting.

FIG. 1 illustrates a spacecraft architecture according to an embodiment.

FIGS. 2A, 2B and 2C show examples of linear, triangular and square configurations of the spacecraft architecture according to an embodiment.

FIGS. 3A, 3B, 3C depict a spacecraft architecture formed into three-dimensional shapes formed by the backbone units, such as a tetrahedron (1), a pyramid (2), or higher-order polyhedra (3), according to an embodiment.

FIG. 4 illustrates a modular spacecraft in a modular spacecraft launch configuration where multiple backbone units are arranged in a circular or polygonal pattern, connected along their long edges to form a cylindrical or polygonal structure, according to an embodiment.

FIG. 5 displays a modular spacecraft with modules attached both inside and outside the backbone units using a standardized interface, creating a cylinder-like structure that handles sideloads, with the backbone units secured to a launch vehicle adapter before launch, according to an embodiment.

FIGS. 6A, 6B depict an internal structure for supporting a modular spacecraft in a launch configuration during launch that is attached to the spacecraft launch adapter at the bottom, according to an embodiment.

FIG. 7 illustrates various modules of a modular spacecraft that can connect to the backbone support structure according to an embodiment.

FIG. 8 depicts an exemplary embodiment of a spacecraft built from a modular spacecraft according to an embodiment.

FIG. 9 depicts another exemplary embodiment of a spacecraft built from a modular spacecraft system using 2 backbone support structures, according to an embodiment.

### DETAILED DESCRIPTION

While the terms “front” and “rear” and “right” and “left” are used herein for describing various elements, the elements are not limited by these terms. Rather, the terms are only used to distinguish one element from another. Instead, the terms are interpreted broadly to include any positional relationship between the elements including, the front, the back, the sides, the top, the bottom, or any combination thereof without departing from the scope of the present disclosure.

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

The following detailed description should be read with reference to the drawings in which similar elements in different drawings are numbered the same. The detailed description and the drawings, which are not necessarily to scale, depict illustrative embodiments and are not intended to limit the scope of the invention. The illustrative embodiments depicted are intended only as exemplary. Selected features of any illustrative embodiment may be incorporated into an additional embodiment unless clearly stated to the contrary.

### Overview

The present disclosure is at least related to a modular spacecraft architecture that includes a central backbone support structure and a plurality of modules that are removably connectable to the backbone support structure that provides a scalable and adaptable platform for spacecraft assembly and launch. The modular design allows various subsystems, payloads, and components to be connected and reconfigured efficiently in space. The architecture is particularly suited for flexible missions requiring dynamic assembly, reconfiguration, and expansion of spacecraft capabilities. The modular spacecraft can include a processor-enabled device for controlling and/or operating the modular spacecraft, e.g., control of the deployment, reconfiguration, or the like of the modular spacecraft and/or operation of the robotic system.

### Backbone Structure

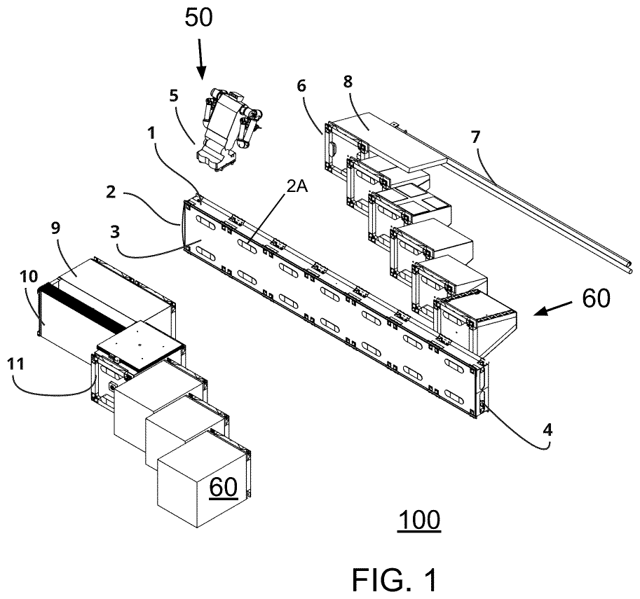

FIG. 1 illustrates components of the modular spacecraft (100), according to an embodiment. Unless expressly stated otherwise, any numerical values in this section are provided as non-limiting, exemplary embodiments to illustrate certain implementations and do not restrict the scope of the invention. The modular spacecraft (100) includes a central backbone support structure or nexus unit (2), which, according to some embodiments, is formed as an aluminum truss frame with optional panel stiffeners on the side and front/back openings, to which a plurality of modules (60) are connectable thereto. In one non-limiting embodiment, the central backbone support structure (2) may be a linear structure that includes a top face, a bottom face opposite the top face, two opposing sides, and first and second ends (4). In an embodiment, the central backbone support structure (2) may have the following dimensions, e.g., about 7.4 m×0.3 m×1.1 m and with a backbone mass of about 800 kg. Along the two opposing sides, the backbone support structure (2) may include a plurality of pairs of slots (3) for connecting to the plurality of modules (60). In an embodiment, seven pairs of slots (3) may be provided along the two opposing sides. While seven pairs of slots (3) are discussed herein, such disclosure is not intended to be limiting. Rather, it is understood that the number of pairs of slots may be based on the length and/or amount of modules to be connected to the backbone support structure (2), for example, two pairs of slots, three pairs of slots, four pairs of slots, five pairs of slots, six pairs of slots, seven pairs of slots, eight pairs of slots, nine pairs of slots, ten pairs of slots, or the like. In some embodiments, the backbone support structure (2) can be configured to be joined with one or more multiple backbone support structures, e.g., joined end-to-end, to increase the length of the backbone support structure. For example, in some embodiments, two backbone support structure units may be joined together to form an about 14.8 m linear string with a combined backbone mass of about 1.6 tonnes. The backbone support structure (2) may be joined together, for example, by using structural joints, which can include fastening means, such as, but not limited to, bolted connections, screwed connections, and/or friction-stir-welded seams, and may be designed or otherwise configured to have a global stiffness requirement to withstand a launch-configuration fundamental frequency, which may exceed about 10 Hz in certain implementations. The backbone support structures (2) can be connected together, in which each of the backbone support structures (2) can have different lengths, e.g., one backbone support structure (2) can have seven slots, while another one of the backbone support structure (2) can have five slots, or the like.

The backbone support structure (2) may include mechanical attachment point(s) or connector(s) for securing the plurality of modules and additional connectors for connecting to one or more of a plurality of networks hosted or provided in the backbone support structure (2). In an embodiment, the backbone support structure (2) can be designed or otherwise configured to host or include a plurality of networks, for example, essential networks (e.g., connection of systems) for operation of the modular spacecraft (100), such as, but not limited to, essential networks including one or more of power distribution network(s) for providing power for operation of any subsystems and instrumentation and equipment, data transmission network(s) for transmitting/receiving data, and thermal fluid network that includes thermal fluid loop(s), in which each of the plurality of essential networks are routed through the backbone support structure (2), e.g., to a regular grid of connectors (3) arrayed along both side faces of the backbone support structure (2), e.g., the opposing sides. For example, in an embodiment, each slot includes co-located mechanical connectors and one or more of electrical connectors, e.g., power harness, for connecting to the power distribution network, data connectors, e.g., data links or wire harnesses, for connecting to the data transmission network, and/or thermal interface connectors, e.g., cam fittings, press-fit fittings, screw fittings, or the like, to the thermal fluid network, e.g., the thermal fluid loops, for connecting one or more modules (60). As such, as illustrated in a representative 7-slot version of the backbone support structure (2), in which the seven slots (3) are provided on each side, the backbone support structure (2) can be connected to a plurality of modules (60), e.g., 14 modules (60) in which each of the plurality of modules (60) are connected to the plurality of networks hosted or provided in the backbone support structure (2).

The top face and/or the bottom face of the backbone support structure (2) can further include robot tracks (1), each implemented, for example, as an integral rail having a width, for example, of about 30 cm, which is configured to support a robotic system 50, e.g., the robotic system 50 is designed or otherwise configured to move along the robot track(s) (1). In some embodiments, sections of the robot track (1) may be modular and/or replaceable.

The first and second ends (4) of the backbone support structure (2) are designed or otherwise configured to provide interfaces for mechanically and/or functionally coupling multiple backbone support structure (2) units together, e.g., end-to-end, enabling larger spacecraft assemblies while continuous power, data, and thermal buses can traverse the joint for connecting the multiple backbone support structures (2) together. In some embodiments, coupling units can be provided to connect the power, data lines, and thermal buses between two adjacent backbone support structures (2) and may include harnesses, cam couplers, screws, collars, or the like.

In certain embodiments, the backbone support structure (2) may be designed or otherwise configured to handle large amount of power, for example, in some embodiments, the backbone support structure (2) may be designed or otherwise configured for power distribution capacity of up to about 100 kW per backbone support structure (2), with up to about 50 kW available for each pairs of slots (3) for each of the modules (60). The data transmission connectors as shown in FIG. 1 (2A) may support at least about 1 Gbps payload/data bandwidth. The thermal fluid loop network (4) can include supply/return quick-disconnects that couple to thermal modules, e.g., modules (60) designed or otherwise configured for thermal management. In one illustrative embodiment, a thermal module may reject up to about 30 kW via deployable radiators. In some embodiments, the backbone support structure (2) can be designed for accommodating a broader range of environmental parameters (e.g., temperature and radiation), e.g., designed for different environmental conditions, which a single module (60) alone cannot accommodate, so that the modules (60) may be tailored to specific orbital regimes (e.g., LEO, MEO, GEO) while remaining compatible with the same backbone support structure (2).

In some embodiments, one or more of the power distribution network, the data transmission network, and the thermal fluid network can be designed or otherwise configured such that the power, data, and/or thermal networks that are routed throughout the backbone support structure (2) are exposed at regular, standardized connection points or intervals along the opposite sides of the backbone support structure (2). Moreover, in some embodiments, the connection to the plurality of networks can be designed or otherwise configured such that the network connections between the module(s) (60) and backbone support structure (2) are automatically established upon mechanical attachment via passive or active connectors.

### Modular System

Unless expressly stated otherwise, any descriptions in this section (including part labels) are provided as non-limiting, exemplary embodiments to illustrate certain implementations and do not restrict the scope of the disclosure.

As discussed above, the modular spacecraft (100) includes a plurality of multiple interchangeable modules (60), in which each of the modules is designed or otherwise configured to house one or more subsystems or payloads. The modules (60) in the modular spacecraft architecture are versatile components that are designed or otherwise configured to provide specific functions/operations for the modular spacecraft (100). In some embodiments, the module (60) can be designed or otherwise configured to perform a wide range of functions, by including spacecraft subsystems or payloads, such as, but not limited to a power subsystem for providing power, such as, a generator, e.g., solar and/or electrical, that includes solar cells and/or batteries, thermal subsystem to provide protection and/or thermal control, attitude control/guidance, navigation and control subsystem for providing attitude and orbit control, communications subsystem which can include antennas for carrying out communications at different frequencies, and a computer subsystem to provide computational resources and control, and/or designed or otherwise configured to serve as deployment platforms, e.g., payloads, for example, for scientific instruments, vehicles, space telescopes, cameras, detectors, satellites, oxygen generation, water generation, or the like. The modules (60) can further contain or include deployable structures, such as, solar panels, radiators, or the like that are attached thereto and connected to the module(s) (60) for further carrying out the specific functions/operations.

The modules (60) include a standardized interface (6) on a side thereof that is configured to allow secure attachment to the connectors (3) along the backbone support structure (2). The modules (60) may vary in size, and may be configured to cover and connect to one or more of the slots (3). The standardized interface (6) may be standardized such that each of the plurality of interchangeable modules (60) include the same connections, such as, but not limited to, a sealing structure, such as a gasket or weather stripping, or the like, magnetic and/or mechanical connectors for connecting to the backbone support structure (2), such as, bolts, cam fittings, collars, space connectors, threaded couplings, power harnesses, wire harnesses, data communications lines, or the like. That is, in an embodiment, the standardized interface can include a connection mechanism configured to securely attach a module (60) to the central backbone support structure (2) or to other module(s); electrical connectors, e.g., power harness, integrated into the standardized interface for transmitting power between the module (60) and the backbone support structure (2) or another module (60); data connectors integrated into the standardized interface for facilitating communication between the module (60) and the backbone support structure (2) or another module (60); a thermal coupling system designed to integrate the module (60) into the thermal fluid loop network of the backbone support structure (2); and/or an alignment and locking mechanism ensuring reliable and repeatable connections during automated or manual assembly and disassembly of the module (60) to the backbone support structure (2). As such, it is appreciated that in some embodiments that include the same standardized interface that is used across all module types, regardless of subsystem function, such standardized interface allows mechanical, electrical, data, and thermal integration through a single standardized connector profile, e.g., the connectors and the standardized interface work together to facilitate the attachment, integration, and reconfiguration of modules and backbone units. In some embodiments, the standardized interface can conform to a published specification that defines mechanical tolerances, electrical pinouts, data protocols, thermal couplings, and robotic interaction geometries, or the like. Moreover, in some embodiments, the use of the standardized interface enables plug-and-play compatibility of modules (60) developed by different vendors, without requiring module-specific adapters, since the interface is standardized.

The modules (60) can further include deployable mechanisms (10), such as, but not limited to, foldable radiators, solar panels, antennas, or the like that can be deployed from the module (60), e.g., after the module (60) is set-up in the desired configuration. In some embodiments, the modules (60) can include additional components, such as, solar power membranes (8), radiation shields, or the like that can be attached externally to one or more of the modules (60).

As such, the modules (60) of the modular spacecraft architecture, as discussed herein, are versatile components that are designed or otherwise configured to perform a wide range of functions and/or operations, including housing spacecraft subsystems, such as power subsystem, thermal subsystem, attitude control/guidance navigation and control subsystem, communications subsystem, and/or computer subsystem. The module(s) (60) can also be designed or otherwise configured to contain or attach deployable structures, such as, solar panels, radiators, antennas, or the like. Thus, the modular spacecraft (100) having the plurality of modules (60) is designed or otherwise configured to provide a modular approach that allows the modular spacecraft (100) to be easily configured, reconfigured, expanded, or adapted to various mission profiles by simply adding, replacing, or repositioning the modules (60) together and/or along one or more backbone support structure(s) (2), as necessary.

In view of the modular spacecraft (100) having the backbone support structure (2) and the plurality of modules (60), as discussed herein, the modular spacecraft (100) is designed or otherwise configured to allow for a high degree of flexibility and/or modularity, e.g., the modular spacecraft (100) can include one or more backbone support structures (2) and a plurality of modules (60) for different combinations and/or uses (e.g., user selection) of modules (60) for connecting to the plurality of networks, e.g., depending on the use and/or needs of the modular spacecraft (100). Moreover, since the modular spacecraft (100) includes a plurality of modules (60) which can connect not only to the backbone support structure (2) but also directly to one another using a second connector (11), which can also include a sealing structure, such as a gasket or weather stripping, or the like, magnetic and/or mechanical connectors, such as, bolts, cam fittings, collars, space connectors, threaded couplings, harnesses, or the like, a wide range of spacecraft configurations can be supported. Moreover, the use of the plurality of modules (60) enable independent or interconnected operation of the integrated plurality of networks between connected backbone support structures, allowing selective control over one or more of the mechanical, power, data, and thermal connections.

As discussed above, the modules (60) are designed or otherwise configured to house one or more subsystems or payloads to provide specific functions/operations for the modular spacecraft (100). That is, the modules (60) can be designed or otherwise configured to take various functions depending on the mission requirements. For example, the modules (60) can be one or more of the following:

Power Module: The power module as illustrated in FIG. 7 can include a large solar membrane that is tensioned by rods along the center and outsides. This rib structure allows for a desirable high eigenfrequency while maintaining low structural mass. The membranes are attached to the rods by a clip or fastening technique. The base of the rod structure is attached to the module through a so-called alpha-beta joint. This is a mechanism that allows continuous full rotation along the axis that goes through the central rod and a 180 deg rotation along the axis orthogonal to the solar membrane. Through this mechanism the membranes can always point to the sun vector for optimal power production.

Battery Module: A battery module contains batteries and charge electronics for those batteries. A battery module expands the modular spacecraft's ability to provide power during phases where solar power is not available, e.g. in eclipse. Having the batteries in a separate module allows for a simple adjustment of the spacecraft design by increasing the number of modules for orbits with longer eclipse periods or higher power requirements. Also surge power needs can be met by adding more battery modules.

Thermal Module: A thermal module is shown in FIG. 7 that spans 2 standard module ports. Another embodiment can be implemented on a single module port. On the top of the thermal module a radiator beam connector is present. This is a cross beam that supports the radiator panels that are attached to the module. The radiator panels can be deployed much like the radiators on the ISS. At the end of the radiator beam connector another radiator beam connector can be attached and the fluid lines connected. This way a radiator module can feature 1, 2, 3 or even more separate radiator modules. The thermal module can contains one or more pumps to pump the coolant through the coolant lines throughout the entire spacecraft. Every module (60) is attached in parallel to the fluid lines and the fluid flow through the modules heat exchanger can be regulated by adjusting the connector valve. The thermal module can also contain a valve assembly that implements various functions to regulate the fluid temperature and provide redundancy in the system. A bypass of the radiator is possible to keep the fluid temperature higher. A secondary pump can also be activated by the switching of valves in the valve assembly.

Attitude Module: An attitude control module as shown in FIG. 7 can include various sensors like a sun sensor, earth albedo sensor, GPS receivers, inertial measurement units (IMU) and other to determine the attitude of the module and hence the spacecraft. It can also contain actuators, particularly single axis or dual axis control momentum gyroscopes, that allow the actuation of the spacecraft attitude. One specific implementation could be a pyramidal configuration of 4 single axis control momentum gyroscopes.

Communication Module: A communication module as shown in FIG. 7 can feature antennas and transmitters as well as receivers for those antennas.

As discussed above, the module(s) (60) and/or the backbone support structure (2) can include the following for the modular connection of the same:

Connectors: The connectors are physical components located on the backbone support structure (2) and on the modules (60). They serve as the points of connection where modules attach to the backbone support structure (2) or to other modules (60) via the standardized interface. Each connector is designed to securely join with another connector or standardized interface, allowing the transfer of mechanical, electrical, data, and thermal connections. The connectors (3) on the backbone support structure (2) are strategically placed on both sides enabling flexible module placement and various spacecraft configurations.

Standardized Interface: The standardized interface (6) is a defined set of physical and functional specifications that ensure compatibility between the modules (60) and the backbone support structure (2). Located on the side of each module (60), this interface includes features that align with the connectors (3) on the backbone support structure (2). The standardized interface is designed to facilitate a secure, reliable connection, ensuring that all mechanical, power, data, and thermal networks can be effectively linked between the module (60) and the backbone support structure (2).

Connection Mechanism: The standardized interface on the module aligns with the connectors on the backbone, enabling a seamless attachment process. This interface provides the necessary alignment and engagement features to ensure that the connectors on the module and the backbone interlock securely.

As such, the modular spacecraft architecture allows for: the flexible assembly, reconfiguration, and expansion of the spacecraft in space; and/or the scalability of the architecture by adding, replacing, or removing module(s) (60) and backbone support structure(s) (2) without disassembling the entire system. The connectors facilitate secure physical connections, while the standardized interface ensures functional compatibility, enabling efficient integration and reconfiguration of spacecraft components. Moreover, the modular spacecraft architecture provides: 1) Functionality Integration: Once connected, the standardized interface and connectors enable the integration of various spacecraft networks (mechanical, power, data, and thermal), which is essential for the module to function properly within the modular spacecraft, as it allows for the transfer of power, data signals, and thermal management fluids, and the like through simple connection thereto; 2) Flexibility and Reconfiguration: The use of standardized interfaces and connectors allows for easy attachment and detachment of modules (60). Moreover, modules (60) equipped with a second connector (11) can be connected to each other, as well as to the backbone support structure (2). This flexibility supports various configurations and reconfigurations of the modular spacecraft, adapting to different mission requirements or operational needs. In summary, the connectors and connection mechanism and the standardized interface work in tandem to provide a modular, adaptable spacecraft architecture.

The modular spacecraft (100) can further include the robotic system (50) that travels along the backbone support structure (2) using a standardized driving base (5), e.g., a standardized driving base that provides an interface between the backbone support structure and various implementations of a robotic system (50). The robotic system (50) can have a torso and two arms much like a human or consist of one or more independent robotic arms mounted directly on the driving base. It could also feature multiple robotic arms mounted on a tower much like the DEXTRE system on the international space station.

The robotic system is responsible for connecting and disconnecting modules (60) both to the backbone support structure (2) and/or to other modules (60). It also replaces conventional deployment mechanisms, simplifying spacecraft construction and qualification.

In an embodiment, the robotic system (50) is designed to traverse the long, narrow side of the backbone support structure, utilizing mechanisms specifically adapted for space conditions, such as, but not limited to, magnetic levitation, electromagnetic track systems for precise control, or rail systems with non-contact bearings to minimize wear and tear. In an embodiment, a rail system with contact bearings can also be used in the robotic system (50). In other embodiments, a geared tooth track system can be used to control the motion and enable the position determination using an encoder.

As such, the robotic system (50) as discussed herein is configured to: travel along the backbone support structure of the modular spacecraft using compatible space-adapted mechanisms, and connect and disconnect modules (60) from the backbone support structure (2) and from each other modules (60), e.g., by connecting/disconnecting the mechanical connectors and/or the connectors for connecting to the one or more of the plurality of networks.

### Configurability

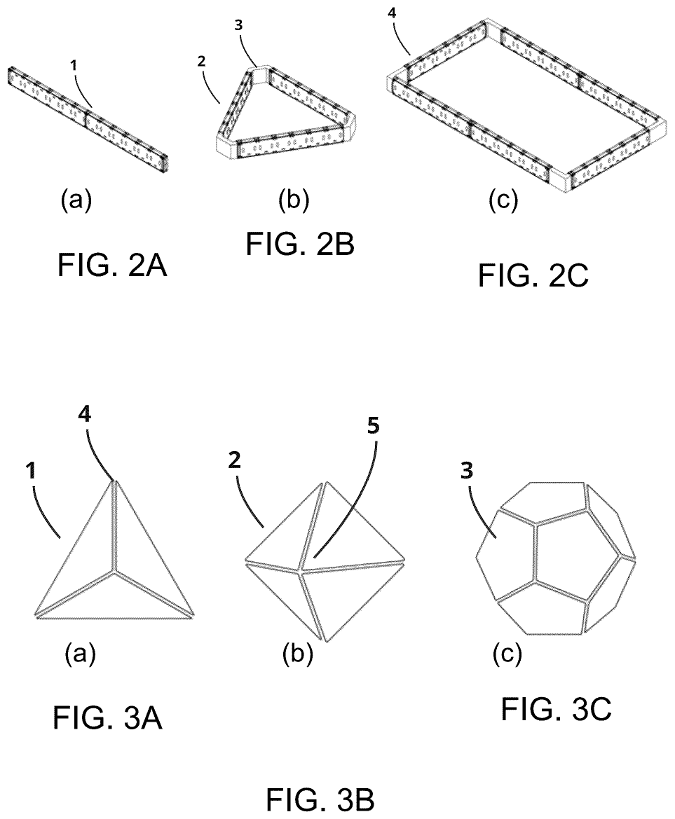

As illustrated in FIGS. 2A, 2B, 2C, 3A, 3B, 3C, the modular spacecraft architecture is designed or otherwise configured to support various two-dimensional and three-dimensional configurations. For example, the backbone support structures can be connected together in linear arrangements and/or T-shapes, as illustrated in FIG. 2A, connected together in a triangular arrangement as shown in FIG. 2B, or squares or rectangles as shown in FIG. 2C, and/or other polygonal shapes. Moreover, other three-dimensional configurations, such as, tetrahedrons, pyramids, and more complex polyhedrons can also be formed by connecting backbone support structures (2) at different angles, as illustrated respectively in FIGS. 3A, 3B and 3C.

It is appreciated that these configurations offer significant adaptability, allowing the spacecraft to be tailored to specific mission requirements. For example, a long string configuration may be suited for payload arrangements where residual atmospheric drag shall be minimal, while a triangular setup may provide much better mechanical stability. A square setup may prove useful for on-orbit manufacturing applications for better access of the robotic systems to various locations on the spacecraft.

In one embodiment as shown in FIG. 9, the modular spacecraft is configured as a LEO science platform comprising a linear string of two backbone support structures (2), also referred to as “nexus units.” Each nexus unit has a length of 7.4 m, giving a total platform length of 14.8 m. The unit cross-section measures approximately 1.1 m in height and 0.3 m in width. The structural mass is approximately 800 kg per unit, for a total of about 1.6 tonnes for the backbone in this configuration.

Each nexus provides 7 standardized module slots per side, resulting in 28 total slots for the two-unit platform. The backbone power distribution supports up to 100 kW per nexus, with up to 50 kW available per module slot. The backbone support structure's data network supports at least 1 Gbps throughput, and the thermal fluid network loop supports approximately 30 kW of heat rejection per thermal module (60). The backbone support structure (2) achieves a fundamental frequency above 10 Hz in the stowed launch configuration.

### Launch Configuration

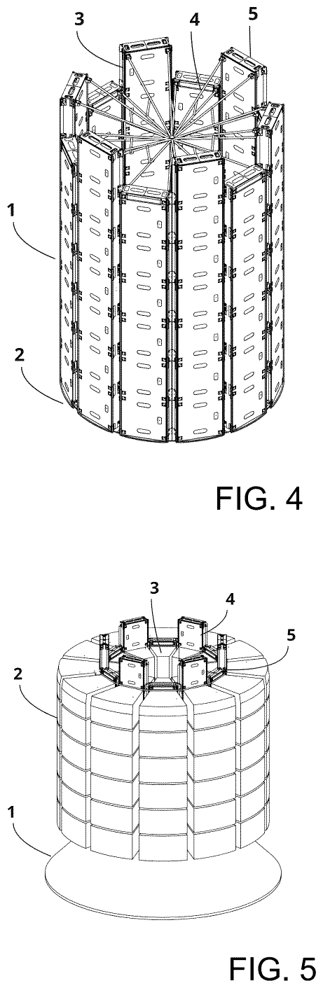

For launch, the modular spacecraft (100) can be designed or otherwise configured for a launch state in which backbone support structures (2) are arranged in a cylindrical configuration, as shown in FIG. 4, in which the backbone support structures (2) are connected along their long edges to form a polygonal shape. The connection along the long edges is either done with a single line or two lines of connections. The connections are executed as bolts or pins or linear toothed rails that interconnect. In some embodiments, a wedge shape with friction based contact can also be used to make the connection between the backbone support structures (2).

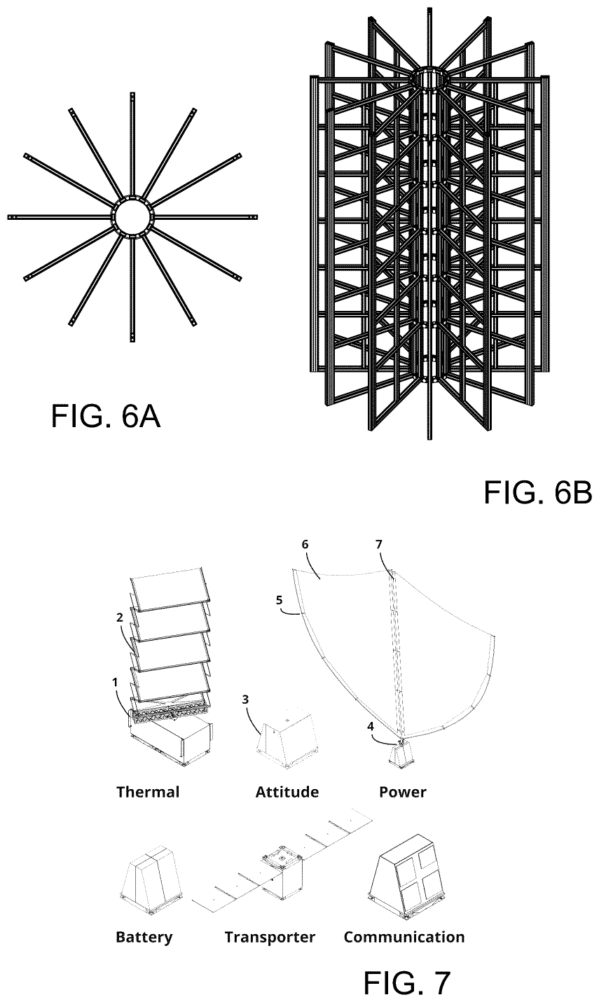

In some embodiments, as illustrated in FIG. 6, a support structure that is a fixed structure that remains attached to the launch vehicle can be provided. The support structure can include vertical elements between the backbone support structures that are used to take vertical launch loads and propagate them into the launch adapter. The internal support structure can be provided in various geometric shapes for supporting the load thereof, e.g., either star-shaped or with fixed vertical elements, to provide support and stiffening. This configuration can support the main structural loads during launch.

On the backbone support structures, modules (60) can be attached along both an inside and outside of the backbone support structures, e.g., optimizing space utilization, as shown in FIG. 5. For example, in an embodiment, the modules (60) on the inside can be either a standard square shape with intermittent free spaces or they feature a conical shape with the sidewalls angled inwards at more or equal to the half angle of the number of backbone units (e.g. for 12 units=360/12=30 and the half angle would be 15 deg). This way a maximal space utilization on the inside is possible for the launch state configuration.

From the specific implementations of the subsystems and the modules (60) in the deployment state and the launch state configurations as discussed above, a series of extended interface definitions and/or operations can arise. Since the robotic system (50) can be implemented in various ways by various vendors as well as the modules (60) themselves being able to be implemented by different vendors, a standardized definition of how these modules and the robot interact is provided.

For instance, since the rods for the solar membrane can be stored on the inside in the launch configuration, attached to several modules (60) extending from the top all the way to the bottom of a backbone support structure. As such, it can be preferred for all the modules (60) on the inside to conform to certain standards, e.g., an envelope is preferably kept clear for the rods, while the outside modules (60) can conform to the same or different standards. Also at certain intervals the rods can be preferably attached to the modules so a structural support can be present. For example, in an embodiment, the solar membranes themselves can be stored on the outside of a power module and a neighboring battery module. This means both of these modules preferably provide an envelope and support structure to house and attach said solar membranes in a folded up packaging.

In another embodiment, the robotic system (50) can be used to set up the rods of the solar membrane or to decouple the launch restraint on the thermal radiators once in orbit. These operations need to be fulfilled by every robot that can be used on the system or by a subset of robots that are deemed essential robots. Essential because the system setup and functioning depends on the presence of such a robotic system. Thus, there is a coupling between the robot and the basic survival of the system.

These extended interfaces are used to define a system of application (programmable) interfaces (APIs) in the soft- and hardware domain to ensure system level functions. The broad implementation of these system level functions across the entire architecture are essential for the modular system to remain flexible.

### Standardized Interfaces and Interoperability

In certain embodiments, the modular spacecraft architecture incorporates a standardized interface system that governs both hardware and software interactions between the backbone support structures (2), modules (60), and robotic systems (50). The standardized interface ensures that modules developed by different vendors can be attached, operated, and reconfigured without the need for custom adapters or redesign of the backbone.

The physical interface may include mechanical connectors with alignment and locking features, such as keyed geometries, guide rails, or latch mechanisms, to guarantee secure and repeatable connections during robotic or manual assembly. Electrical contacts integrated into the interface provide power transfer to and from each module (60), while data connectors enable high-bandwidth communication between the backbone support structure (2) and modules (60). A thermal coupling system, such as quick-disconnect fluid fittings or embedded heat transfer surfaces, may be incorporated to integrate modules into the backbone support structure's thermal fluid network loop. The standardized interface is designed to be modular and reusable across different sides of a module, allowing flexible configurations such as module-to-backbone and module-to-module connections.

In addition to physical connections, the architecture employs an extended set of interoperability definitions to manage shared infrastructure and robotic interaction. These definitions can specify volumetric envelopes that must remain clear for deployment mechanisms (e.g., solar membranes or radiator rods), designated attachment points for common hardware, and robotic grasping or manipulation profiles that enable any compliant robotic system to operate on modules from different vendors. These extended interface specifications ensure that multi-module systems can be coordinated and deployed without physical or functional conflicts.

The standardized interface system is further defined by a published specification that encompasses both hardware and software layers. The hardware specification defines mechanical tolerances, pinouts for electrical connections, data protocols, thermal couplings, and physical features required for robotic handling. The software specification establishes a common application programming interface (API) that each module and robotic system exposes. This API may include functions for module identification, self-description of capabilities, negotiation of power and data network access, reporting of health and status, and execution of configuration or deployment commands.

By conforming to these published specifications, third-party vendors can develop modules that are interoperable with the modular spacecraft backbone support structure and robotic systems without requiring special accommodations. Plug-and-play compatibility is achieved because compliance with the interface specification ensures that modules will automatically integrate mechanically, electrically, thermally, and logically into the spacecraft. The backbone support structure and robotic systems may further include verification routines that confirm module identity and compliance with the published profile before completing final engagement of the connectors.

This interoperability framework allows the spacecraft architecture to operate as an open ecosystem, supporting certified third-party modules and reducing integration barriers. As a result, spacecraft built from this architecture can scale more easily, incorporate new technologies rapidly, and extend mission lifetimes by introducing upgraded or replacement modules in a controlled and standardized manner.

### Autonomous Reconfiguration and Robotic Operations

In various embodiments, the modular spacecraft (100) is configured such that all assembly, reconfiguration, and deployment operations can be performed autonomously by robotic systems without requiring human extravehicular activity (EVA). This approach eliminates the need for crew intervention during critical integration tasks, reducing operational risk and mission cost while enabling assembly in orbital regimes that may be inaccessible to humans.

For example, in an embodiment, the robotic system (50) may traverse along the backbone structure using rails, geared tracks, or other space-adapted mechanisms, and may be equipped with multiple manipulators capable of grasping, aligning, and securing modules. Each robotic manipulator may be fitted with tools or end-effectors designed for engaging the standardized interface features of the modules, including latches, alignment pins, electrical connectors, and thermal couplings.

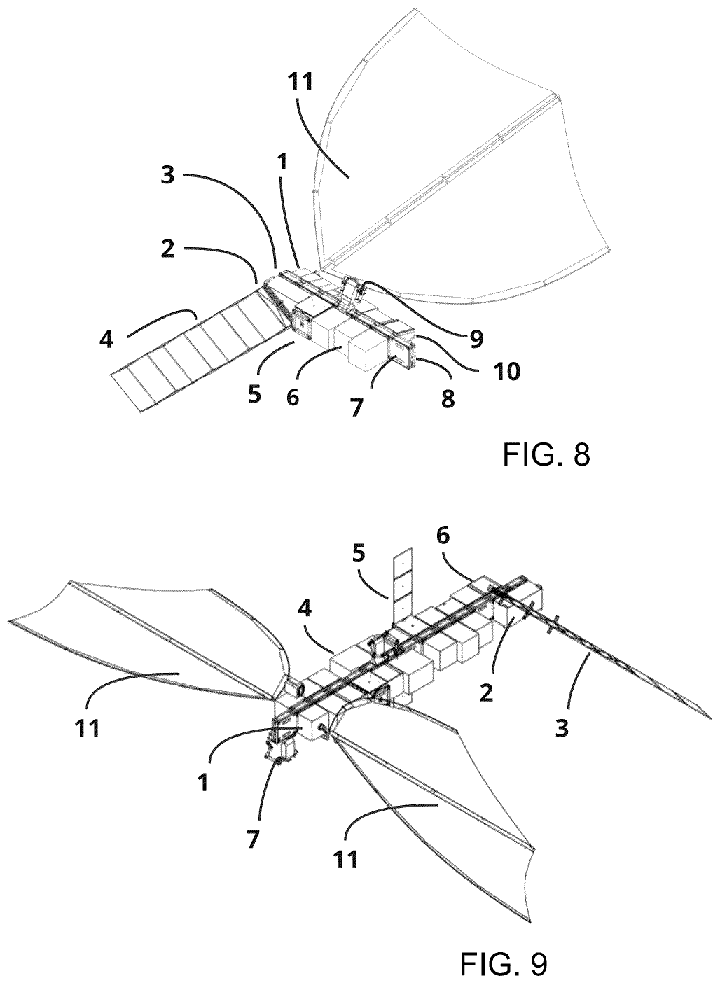

During operation, the robotic system is capable of autonomously detaching modules (from the launch configuration) from a slot on the nexus backbone support structure, transporting them along the backbone support structure, and reconnecting them in operational positions according to a pre-defined or dynamically updated spacecraft configuration plan, e.g., as illustrated in FIGS. 8 and 9. The system may also expand the backbone support structure (2) by connecting additional backbone support structure (2), aligning and securing them through compatible end connectors.

Autonomous routines may further include health checks and redundancy measures to ensure that network connections for power, data, and thermal fluid networks are fully established after module placement. In certain embodiments, the robotic system (50) can be configured to execute reconfiguration routines stored in onboard memory or uplinked from ground control. These routines may be triggered by mission requirements, such as changes in payload operations, evolving orbital conditions, or fault recovery scenarios.

The modular architecture supports dynamic in-orbit reconfiguration without human intervention. For example, modules may be repositioned to optimize thermal balance, replace a failed subsystem, or repurpose the spacecraft for a new mission objective. The robotic system can execute these changes autonomously, reducing reliance on pre-planned manual assembly and extending the spacecraft's adaptability throughout its operational lifetime.

By ensuring that all module installation, replacement, and deployment functions are performable exclusively by robotics, the modular spacecraft achieves a high degree of autonomy. This design philosophy allows for scalable, persistent infrastructures in space that can be assembled, maintained, and evolved without direct crew support.

### Operation

In view of the above modular spacecraft (100), a method for deploying the modular spacecraft structure in space is provided. The method can include launching the modular spacecraft (100) in a launch configuration, e.g., compact configuration, in which the spacecraft comprises a backbone support structure and a plurality of modules connected to the backbone support structure. In the launch configuration, the backbone support structures (2) are arranged in a cylindrical configuration, as shown in FIG. 4, in which the backbone support structures (2) are connected along their long edges to form a polygonal shape. The method can further include positioning the modular spacecraft (100) in an intended orbital location, e.g., LEO, MEO, GEO, and the robotic system (50) can be activated to traverse along the backbone support structure. The robotic system (50) can be configured to: detach one or more modules of the plurality of modules (60) from the compact configuration; and reposition and connect the one or more modules (60) to the backbone support structure (2) or to other modules (60) based on a pre-determined configuration. For example, in an embodiment, the pre-determined configuration can be an operational position or dynamically updated spacecraft configuration plan, e.g., as illustrated in FIGS. 8 and 9, in which the modular spacecraft (100) is expanded along one or more of the backbone support structures (2) by connecting the modules (60) in the predetermined configuration. In some embodiments, the method can further include expanding the backbone support structure (2) by connecting additional backbone support structure(s) (2) to form a desired structural configuration, wherein the desired configuration includes a linear configuration, a T-shaped configuration, or polyhedral configuration. The method can further include, after expanding the modular spacecraft (100) in the operational pre-determined configuration, the modules can be further controlled to deploy foldable or extendable components, in which the components can include solar panels, antennas, or radiators, e.g., to transition the modular spacecraft from a stowed state to an operational state. Moreover, in view of changing circumstances and/or operations, the method can further include dynamically updating the configuration of the modular spacecraft in response to changes in mission objectives, environmental conditions, or component failures. For instance an electric thruster can be mounted in the rear location during a thrust phase but moved to a different location once the target orbit is reached. In another example, in an embodiment, in which the mission objective, e.g., scientific payload requirement changes, for example, for taking radiation measurements instead of telescopic images, the modular spacecraft (100) can be configured to modify or change the operation of one or more of the modules (60) by deploying radiation detectors and retracting the telescope. Similarly, if the environmental condition changes, e.g., increased temperatures due to solar flare or the like, one or more of the modules (60) can be further provided for providing additional thermal dissipation. Additionally, if one or more of the components and/or modules fail, the robotic system (50) can be configured to detach and/or deactivate, e.g., disconnect from one or more of the plurality of networks, the failed component and/or module.

### Advantages of the Invention

The modular spacecraft architecture described offers several key benefits:

Scalability: The backbone and modular approach allow for expansion and reconfiguration without requiring complete disassembly.

Flexibility: The architecture can accommodate a wide range of mission profiles by supporting different module functions and configurations.

Simplified Construction: The use of a robotic system reduces the complexity of traditional deployment mechanisms, easing construction and maintenance.

Reusability: Modules can be swapped or upgraded, extending the operational lifespan of the spacecraft.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A modular spacecraft comprising:
a backbone support structure configured to provide structural support and host a plurality of networks; and
a plurality of modules connected to the backbone support structure,
wherein the plurality of modules includes mechanical connectors for securing the plurality of modules to the backbone support structure, and
wherein one or more of the plurality of modules further include connectors for connecting to one or more of the plurality of networks in the backbone support structure, wherein the one or more of the plurality of networks include one or more of a power distribution network, a data transmission network, and a thermal fluid network.

2. The modular spacecraft of claim 1, wherein one or more of the plurality of modules is configured to be detachably connectable to the backbone support structure, wherein each module comprises a standardized interface that includes the mechanical connectors, and the connectors for connecting to the one or more of the power distribution network, the data transmission network, and the thermal fluid network.

3. The modular spacecraft according to claim 2, wherein each of the modules is configured to contain one or more spacecraft subsystems or payloads, wherein each of the modules is configured to perform specific functions individually and/or in combination with other modules.

4. The modular spacecraft according to claim 2, wherein each of the modules further comprises a second connector for enabling inter-module connection, the second connector providing at least a mechanical connection and connection to one or more of the power distribution network, the data transmission network, and the thermal fluid network between connected modules.

5. The modular spacecraft of claim 1, further comprising a robotic system configured to perform one or more of: moving along the backbone using a standardized driving interface; connecting and disconnecting one or more of the plurality of modules from the backbone support structure and/or from another module; reconfiguring one or more of the modules.

6. The modular spacecraft of claim 1, wherein the backbone support structure is configured to be connected to other backbone support structures to form two-dimensional or three-dimensional configurations, wherein the two-dimensional or three-dimensional configurations include a T-shaped configuration, a triangular configuration, a rectangular configuration, and a polyhedral configuration.

7. The modular spacecraft of claim 1, wherein the backbone support structures are arranged for launch in a cylindrical or polygonal configuration with the plurality of modules attached on both interior and exterior sides of the backbone support structure.

8. The modular spacecraft of claim 1, wherein the modular spacecraft in a launch configuration is arranged in a way such that the plurality of modules are arranged in a wedge- or cone-shaped modular layout to maximize spatial packing efficiency.

9. The modular spacecraft of claim 5, wherein each module of the plurality of modules and the robotic system expose a standardized hardware-software interface configured to support interoperability with modules developed by third-party vendors.

10. A backbone support structure for a modular spacecraft architecture, the backbone support structure comprising a linear structure configured to provide a structural framework to support a plurality of modules, and mechanical connectors for connecting to a plurality of modules,
wherein the backbone support structure is configured to host a plurality of networks, wherein the plurality of networks include one or more of a power distribution network, a data transmission network, and a thermal fluid network, and
wherein the backbone support structure includes a standardized interface for detachably connecting one or more of the plurality of modules and/or other backbone support structures in various orientations.

11. The backbone support structure of claim 10, further comprising robot tracks for facilitating movement of a robotic system along a length of the backbone support structure for connecting and disconnecting one or more of the plurality of modules.

12. The backbone support structure of claim 10, wherein the backbone support structure is configured to be connected to other backbone support structures to form two-dimensional or three-dimensional configurations, wherein the two-dimensional or three-dimensional configurations include a T-shaped configuration, a triangular configuration, a rectangular configuration, and a polyhedral configuration.

13. A method for deploying a modular spacecraft structure in space, the method comprising:
launching a modular spacecraft in a compact configuration, wherein the spacecraft comprises a backbone support structure and a plurality of modules connected to the backbone support structure;
positioning the modular spacecraft in an intended orbital location;
activating a robotic system to traverse along the backbone support structure, wherein the robotic system is configured to:
detach one or more modules of the plurality of modules from the compact configuration;
reposition and connect the one or more modules to the backbone support structure or to other modules based on a pre-determined configuration.

14. The method of claim 13, further comprising expanding the backbone support structure by connecting additional backbone support structure to form a desired structural configuration, wherein the desired configuration includes a linear configuration, a T-shaped configuration, or polyhedral configuration.

15. The method of claim 13, further comprising: deploying foldable or extendable components of the modules, wherein the components include solar panels, antennas, or radiators, to transition the modular spacecraft from a stowed state to an operational state.

16. The method of claim 13, further comprising: establishing and verifying connections between one or more of the power network, the data network, and the thermal fluid network, as the modules and backbone support structure are deployed.

17. The method of claim 13, further comprising: dynamically updating the configuration of the spacecraft in response to changes in mission objectives, environmental conditions, or component failures.
